(19) United States
(12) Patent Application Publication
(10) Pub. No.: US 2005/0273470 A1
(43) Pub. Date: Dec. 8, 2005

(54) Interactive system for dynamic generation of a user-customized composite digital image

(76) Inventor: Cynthia J. Heigold, Encinitas, CA (US)

Correspondence Address: THE MAXHAM FIRM, 750 "B" STREET, SUITE 3100, SAN DIEGO, CA, 92101, US

(21) Appl. No.: 10/851,571

(22) Filed: May 20, 2004

(51) Int. Cl. G06F 7/00

(52) U.S. Cl. 707/104.1

(57) ABSTRACT

System and method for the dynamic generation of a user-customized composite digital image (CDI). In accordance with some embodiments, the CDI is generated by identifying one or more user supplied digital images, and selecting a CDI template from a library of pre-stored CDI templates. Each CDI template stored in the library may include one or more user modifiable template elements, and one or more locations where the identified digital images can be positioned or otherwise located. If desired, one or more of the user modifiable template elements of the selected CDI template may be modified using, for example, images stored in a template element image library. The generation of the user-customized composite digital image may be realized by combining the selected CDI template, the identified digital images, and the user modifiable template elements.

### BACKGROUND OF THE INVENTION

1. Field of the Invention

The present invention relates generally to the creation of composite digital images, and in particular to a system for generating customized composite digital images using a dynamic process that supports the combination of digital images and user modifiable template elements.

2. Discussion of the Related Art

Presently, a number of systems provide for the creation of composite digital images using images obtained from a library of templates and user supplied digital images. In general, these systems utilize “static” templates having a certain number of unmodifiable features. For instance, a static template may include a particular location where a user-selected image may be inserted, and a predetermined number of image elements such as background patterns, graphics, and text elements, positioned at various locations within the template.

In general, static templates do not permit users to change or modify any of the features or image elements of the template, and thus users are forced to accept the design arrangement provided by the template. Some conventional systems attempt to meet user's needs for customization by providing a number of different templates with differing design options, but this technique requires considerable foresight and designer effort since each template variation must be individually created before being presented to the user.

### SUMMARY OF THE INVENTION

The invention provides for increased customization in the design and creation of composite digital images. In accordance with some embodiments of the invention, a system and method for generating a user-customized composite digital image (CDI) includes the identification of one or more user supplied digital images, and selecting a CDI template from a library of pre-stored CDI templates. Each CDI template stored in the library may include one or more user modifiable template elements, and one or more locations where the identified digital images can be positioned or otherwise located. The user modifiable template elements of the selected CDI template may be modified using, for example, the images stored in a template element image library. The generation of the user-customized composite digital image may be realized by combining the selected CDI template, the identified digital images, and the user modifiable template elements.

### BRIEF DESCRIPTION OF THE DRAWING

The above and other aspects, features, and advantages of the present invention will become more apparent upon consideration of the following description of preferred embodiments, taken in conjunction with the accompanying drawing figures, wherein:

FIG. 1 depicts a representative network environment suitable for implementing the system and methods of the present invention;

FIG. 2A shows a rendering of a composite digital image (CDI) within an exemplary graphical user interface (GUI);

FIG. 2B shows the GUI of FIG. 2A having a pop-up menu responsive to a user input;

FIG. 3 is a block diagram showing various components of a digital image composite engine that may be used to generate a CDI;

FIGS. 4A-4D show four exemplary CDI templates having unique template elements;

FIGS. 5A-5D show a user selected CDI template having four different types of user photos inserted within the CDI template;

FIGS. 6A-6D show a user selected CDI template having four different types of background patterns;

FIGS. 7A-7D show a user selected CDI template having four different types of graphic patterns;

FIGS. 8A-8D show a user selected CDI template having four different types of photo border patterns;

FIGS. 9A-9D show a user selected CDI template having four different types of text-based titles;

FIGS. 10A-10D show a user selected CDI template having four different types of user-editable text elements;

FIG. 11 is a block diagram showing various components of a digital image composite engine that may be used to a generate a CDI, in accordance with an alternative embodiment of the invention; and

FIG. 12 is a flowchart showing an exemplary process for the creation and subsequent delivery of a CDI image according to embodiments of the invention.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention.

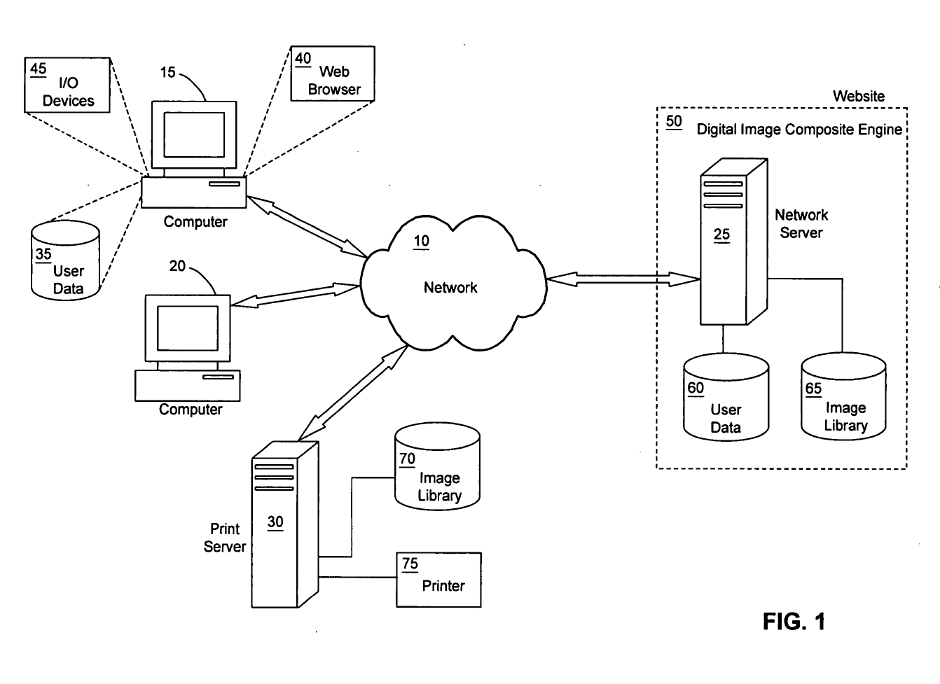

FIG. 1 depicts a representative network environment suitable for implementing the system and methods of the present invention. The illustrated environment comprises network 10 interconnecting a plurality of computers 15 and 20 with network server 25 and print server 30. Network 10 may be implemented using a conventional network topology such as a wide area network (WAN), metropolitan area network (MAN), local area network (LAN), virtual private network (VPN), integrated services digital network (ISDN), asynchronous transfer mode (ATM) network, or the Internet, among others.

Data communication between the components depicted in FIG. 1 may be implemented using conventional packet switched network communication protocols. Examples of such networking protocols include hypertext transport protocol (HTTP), file transport protocol (FTP), transmission control protocol/internetworking protocol (TCP/IP), Ethernet, fiber distributed data interface (FDDI), token bus or token ring networks, serial line IP (SLIP) protocols, and the like.

Other types of data network interfaces and protocols are within the scope of the present disclosure. In particular, computers 15 and 20 described below may generally be configured to transmit data to, and to receive data from, other networked components using wireless data communication techniques, such as infrared (IR) or radio frequency (RF) signals, for example, or other forms of wireless communication. Accordingly, it is to be realized that network 10 may be implemented as an RF personal area network (PAN) or a wireless LAN or WAN, for instance. In that regard, various suitable wireless communication standards and protocols may be used including global system for mobile communications (GSM), code division multiple access (CDMA), time division multiple access (TDMA), IEEE 802.11 family of protocols, wireless application protocol (WAP), short message service (SMS), and the like.

It will be appreciated that the foregoing examples of networking technologies are illustrative only, and that the present disclosure is not intended to be limited with respect to the specific networking protocols or communication standards employed by any of the components illustrated and described herein.

Computers 15 and 20 may be specific or general purpose computers such as personal computers having an operating system such as DOS, Windows, OS/2, or Linux; Macintosh computers; computers having JAVA OS as the operating system; graphical workstations such as the computers of Sun Microsystems and Silicon Graphics, and other computers having some version of the UNIX operating system such as AIX or SOLARIS of Sun Microsystems; or other network-enabled computing devices, electronic apparatus, or computerized systems including, but not limited to, laptop and hand-held computers, personal data assistant (PDA) devices, wireless telephones, and various types of WAP and SMS enabled devices.

FIG. 1 shows two individual computers 15 and 20 coupled to network server 25, but the invention is operable with any number of such computers. For clarity and ease of discussion, further description of the invention will make reference to a single computer, but the disclosed principles apply equally to any of a number of computers that can be placed in communication with network server 25. FIG. 1 also shows network and print servers 25 and 30 as single servers, but the present invention may be implemented using multiple network servers, or multiple print servers, or both.

In accordance with some embodiments, computer 15 may include storage unit 35 for storing data, and may be implemented using any suitable volatile or non-volatile memory, or both, or a storage device including random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, or other similar memory or data storage means.

Computer 15 may execute a Web browser application 40, such as Microsoft Internet Explorer or Netscape Navigator, for providing access to websites. If desired, computer 15 may also be configured with one or more input/output devices 45. Specific examples of such devices include printers, scanners, display devices such as an LCD, CRT, or plasma monitor, fax machines, digital cameras, digital video cameras, analog-to-digital devices, and the like.

The embodiment of FIG. 1 shows digital image composite engine 50 residing on network server 25. The network server may be implemented using a commercially available network application server capable of responsively providing webpage content to computer 15. The network server is provided with a suitable database 60 for storing user data such as uploaded digital photos, user information, generated composite digital images, and the like. In addition, the network server may also have an additional database 65 for storing the various digital image templates, template elements, program code, and other data supporting the operation of the digital image composite engine website.

FIG. 1 further shows print server 30 having database 70 and one or more printers 75. Similar to database 65, database 70 may be used for storing the various digital image templates and template elements that may be used during the operation of the digital image composite engine website. In general, databases 65 and 70 may store the same, or substantially the same, set of graphical image libraries. The specifics of the various types of graphical images that may be stored in databases 65 and 70 will be described in more detail in conjunction with later figures.

Database 70 is not always required for printing digital composite images generated by users since the rendering of the CDI image may alternatively be performed by server 25 or computer 15, for example. This aspect of the invention will be discussed in more detail below. Note also that FIG. 1 shows the user data and image library implemented as two separate databases 60 and 65, but such an arrangement is not required and a single database having both types of data may be used.

Printer 75 may be implemented using known printing systems and devices that can print images comprising digital photos and graphics at an acceptable level of resolution. Examples of suitable devices that may be used for implementing printer 75 include photographic mini-lab digital printers with laser, CRT printers, MVLA and other exposure systems, electro-photographic toner based digital printers, ink-jet printers, laser printers, thermal printers, dye sublimation printers, and the like.

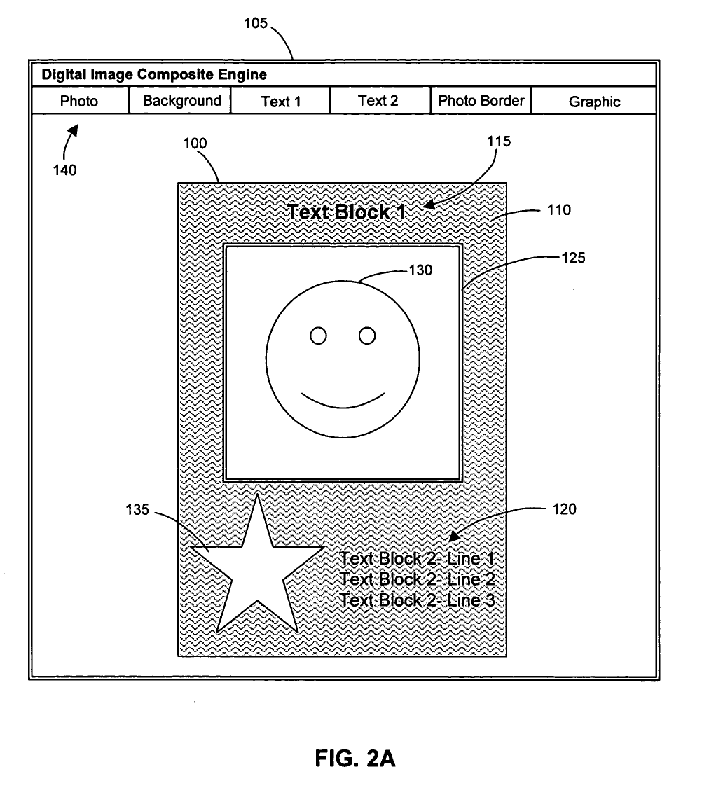

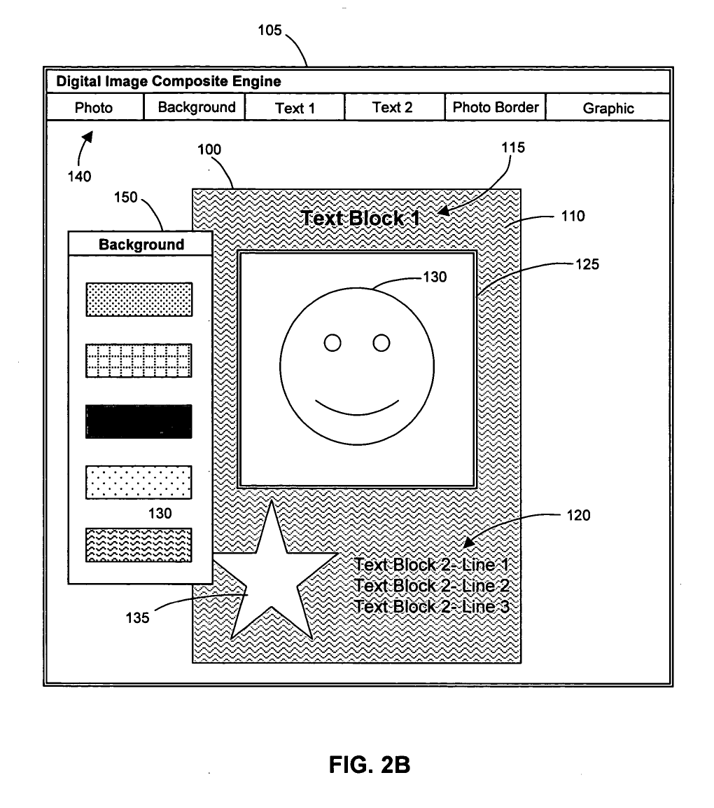

FIG. 2A shows a rendering of composite digital image (CDI) 100 within an exemplary graphical user interface (GUI) 105. The GUI may be presented to a user using web browser 40 of computer 15, as shown in FIG. 1. In the example of FIG. 2A, CDI 100 is formed from various individual template elements. Specifically, CDI 100 includes background 110, first and second text elements 115 and 120, and border 125. Border 125 defines a predetermined or user selectable region in which a user selected graphic or photo 130 may be placed or otherwise inserted. A star-shaped graphical template element 135 is shown positioned relative to the photo border and the second text element.

CDI 100 may be characterized as a digital image that is formed from a layered combination of several digital elements. In contrast to conventional digital image generation systems, CDI 100 does not utilize a fixed or static template process. Instead, CDI 100 is dynamically formed using a base template design having a number of selectable or modifiable template elements. That is, a user can create a customized composite digital image by selecting from a variety of possible choices for each template element utilized in the composite digital image. The template elements are not specific to any base template design, and can be reused by other template designs.

Although the conventional static template design process may provide a number of different design options, this technique requires considerable foresight and designer effort since each template variation must be individually created before being presented to the user. In contrast, the dynamic template process of the present invention releases the user from the artistic bonds of the static template process and allows the user to freely create a personalized and custom design. In accordance with the present invention, the user is provided with a set of artistic tools, which are in the form of selectable template elements, in which to modify the base template design. This approach permits the creation of an almost unlimited number of customized designs using a few basic templates and a number of reusable template elements.

With this understanding, in accordance with one embodiment, GUI 105 may include edit menu 140 providing editing buttons that are separately associated with each individual template element of CDI 100. In general, the edit menu, which is shown implemented as a tool bar, functions as an element editor that enables interactive editing of one or more template elements of the CDI. As shown, edit menu 140 has a “photo” button for selecting user photo 130, a “background” button for selecting background 110, “text 1” and “text 2” buttons for entering or changing first and second text elements 115 and 120, respectively, a “photo border” button for selecting photo border 125, and a “graphic” button for selecting graphical element 135. By selecting a particular button of edit menu 140, a user may be presented with a pull-down or pop-up menu, for example, providing a choice of possible options for changing the identified template element.

FIG. 2B shows a rendering of a pop-up menu generated in response to user selection of the background button of edit menu 140. In this figure, pop-up menu 150 provides the user with various pattern options, color options, or both, for background 110.

To change the background pattern of CDI 100, for example, a user could simply select the desired background from the list of possible background pattern options presented in the background pattern pop-up menu. Upon selecting the desired background pattern, background template element 110 of CDI 100 could be updated in real-time providing a user with nearly instantaneous feedback of their selection, while other template elements remain as previously defined. This real-time updating aspect of the invention is facilitated by the dynamic template design of the composite digital image engine. Each of the remaining template elements of CDI 100, such as first and second text elements 115 and 120, photo border element 125, and graphical element 135, may be modified or edited in a similar manner by selecting the appropriate button in edit menu 140.

FIGS. 2A and 2B illustrate one technique for generating CDI 100 by selecting possible design choices for each template element from a pop-up window, but many other techniques are possible. For example, the user may alternatively be presented with a pull down menu that provides the various template element edit options. Another alternative includes the use of a cursor “hover” operation to trigger the appropriate edit menu. In this alternative, the user would position the cursor over a particular template element in which a change or modification is desired. A specific example is where a user positions the cursor over a portion of background 110. After a predetermined period of time, the user would be presented with pop-up menu 150, for example, which displays the various background pattern options.

Another option is to provide the user with a template element editor that presents possible design choices for each template element in an interactive wizard environment. The wizard may be arranged as part of a multi-stage design process such that the user is interactively stepped through each of the possible template element edit options. Each stage of the interactive wizard may address a particular template element of CDI 100. A specific example is a six-stage wizard in which each individual stage permits modification of a particular template element comprising the CDI. In essence, such a wizard combines the functionality of each of the edit functions of edit menu 140 into a user friendly, interactive wizard.

Yet another option is to automatically suggest possible design choices for one or more of the template elements. This option would randomly or pseudo randomly define particular design features for one or more of the template elements. This option may require the user to first submit answers to a questionnaire upon which the randomizer would base its decision. Such a questionnaire may identify, for example, the likes or dislikes of the user, the age of the user, favorite types of leisure activities, profession, political affiliations, and the like. The specifics of the questionnaire are not essential to the invention. The key is that information about the user or an intended recipient of a generated digital composite image is somehow garnered so that the system can intelligently suggest design choices that would appeal to the user.

In some situations, the system would not require the user to submit a questionnaire but could instead provide suggested design choices for particular template elements using a truly random selection process or a process utilizing some form of artificial intelligence (AI). A design choice selection process using Al could consider, among other things, particular design choices selected by other users of the system. For example, the system could track the design selections of the various template elements over a period of time to identify popular arrangements. The most popular design arrangements may in turn be suggested to new users. A design process using AI could therefore leverage the artistic skill of others with relatively minimal overhead at the system level.

Drag and drop operations are yet another option for providing the user with possible design choices for each template element. Using this technique, the user would be presented with some or all of the possible design choices for each template element. As an example, the background patterns presented in pop-up menu 150 could be presented in the same or nearby window that CDI 100 is rendered. The user could then move the cursor over the selected pattern, select the desired pattern using the mouse button, and then “drag” the pattern onto background portion 110 of the CDI. Each of the remaining template elements of CDI 100 may be modified in a similar manner.

FIGS. 2A and 2B show an exemplary arrangement of various template elements that may be used to form CDI 100. However, it is to be realized that the present invention is not limited to any single arrangement or number of template elements and that a vast number of different arrangements are possible and within the teachings of the present disclosure. For example, CDI 100 is shown with the simple arrangement of a single user photo 130. A possible alternative is to have two, three, or more user photos all located within the boundaries of the CDI. Such a multi-photo arrangement is popular with users creating, for example, brochures, announcements, and photo album layouts where each album page includes several individual photos. Similarly, the CDI may be formed using two, three, or more graphic template elements 135. Another possibility is to limit the number of user editable template elements such that CDI 100 only has photo 130 and one or two, for example, template elements that can be modified by the user. If desired, CDI 100 may alternatively include a single text element, more than two text elements, or the text element feature of the CDI may be omitted altogether.

Another alternative is to permit user or system modification of the size and orientation of the various template elements of CDI 100. Using user photo 130 again as an example, the CDI may include one or more photos that differ in size from that shown in FIGS. 2A and 2B. If desired, such photos may be rotated 45°, for example, relative to a normal or usual viewing position (that is, the position from which a person would customarily view the photo) within the CDI to create a unique photo arrangement. Another technique is to overlap one or more of the template elements either as a part of a basic template design, or as an additional user selectable parameter. Note also that the positioning of the various template elements within CDI 100 is merely exemplary, and that these elements may be varied from that shown in FIGS. 2A and 2B.

It is to be understood that the user interface depicted in FIGS. 2A and 2B is merely exemplary, and that the present invention is not so limited. Other user interface technologies, both currently existing and those which may become available in the future, may also be used.

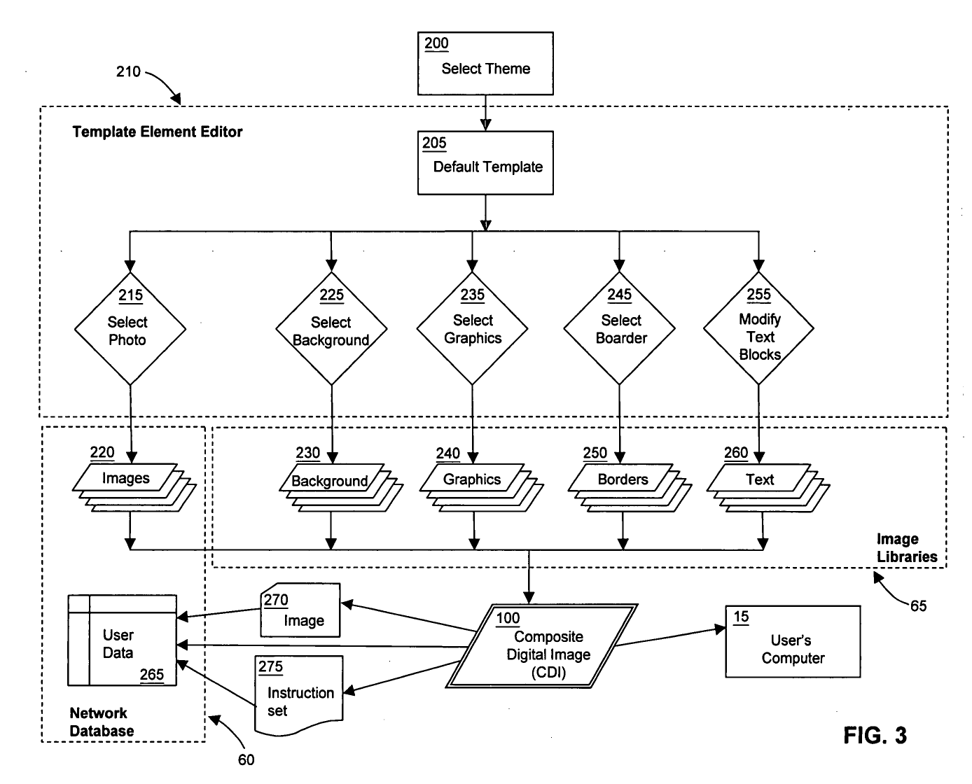

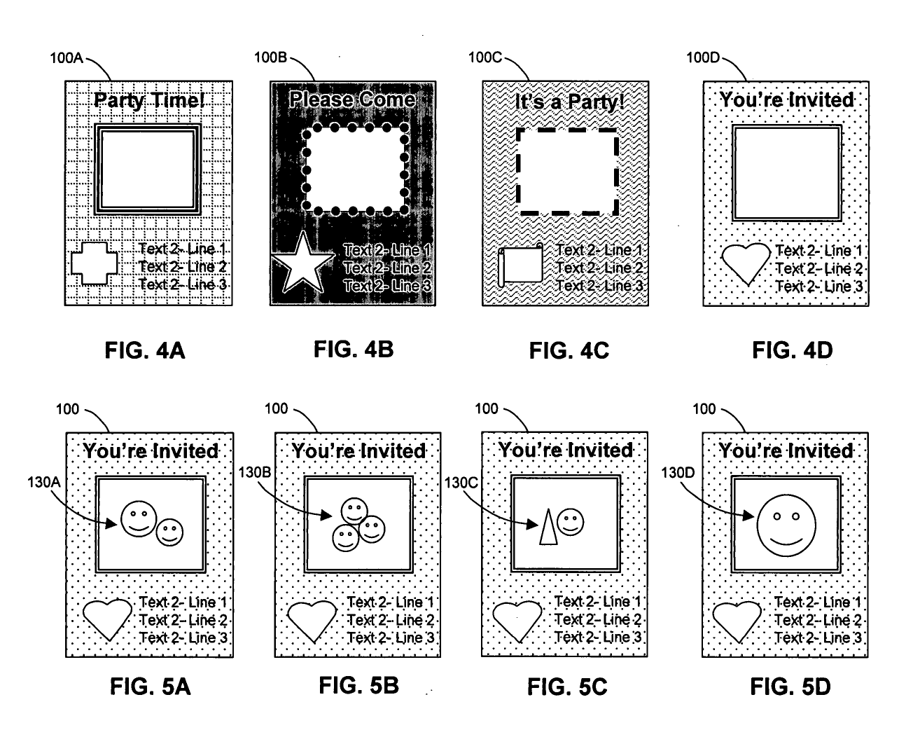

FIG. 3 is a block diagram showing various components of the digital image composite engine which may be used to generate composite digital image (CDI) 100. This figure will be described with occasional reference to FIG. 1, and the various composite digital images depicted in FIGS. 4A-4D through 10A-10D. The digital image composite engine may be implemented using computer software residing at network server 25, computer 15, or both. The digital image composite engine may be implemented using any suitable computer language such as XML, HTML, C, C++, Java, amoung others.

In embodiments where the digital image composite engine is executing on server 25, the generation of the CDI is typically accomplished by a user first contacting the appropriate website using, for example, the network arrangement of FIG. 1. As shown in block 200 of FIG. 3, the user may first be required to select the basic theme of the CDI. In general, the purpose of theme selection is to identify the general nature of the photos that are to be inserted into CDI 100. The types of themes that a user may be offered to select from include, for example, anniversary, children, newborn babies, birthday, Christmas, everyday events, friends and family, Hanukkah, occupations, kids, locations, seasonal events, special occasions or events, pets, wedding and romance, sports, and Thanksgiving, among others. FIGS. 4A-4D show four different CDIs (100A, 100B, 100C, and 100D) representing four different template themes. Each of the CDIs shown in these figures reflect different themes such that they each have unique titles, backgrounds, photo borders, and graphics. Note that the CDIs shown in this figure do not have a photo since no such photo has yet been selected by the user.

Returning to block 200 of FIG. 3, the user may select a particular theme and the system will responsively generate a default template which will be presented to the user (block 205). More specifically, the selection of a particular theme will result in the generation of a default template, which is embodied in CDI 100. The generated CDI image may be communicated to the user's computer 15 for viewing. It is to be understood that during the image creation process, the CDI may be dynamically updated based upon the editing function selections entered by the user.

Template element editor 210 is shown having various template element editing functions. Some or all of these editing functions will typically be presented to the user at some point during the CDI generation process. The template element editor may be implemented using any of the methods previously described with respect to FIGS. 2A and 2B (for example, pop-up menu, pull-down menu, hover, interactive wizard, drag and drop, automatic generation, and the like).

Typically, the CDI is communicated to the user in a resolution that is appropriate for the display device that is being used. For instance, if the user is using a conventional CRT or LCD computer display, CDI 100 may be communicated to the user in a format suitable for displaying at a resolution of 640×480 or 1024×768, for example. On the other hand, the resolution of CDI 100 may be decreased if the user is using a device having a more limited display. For example, if a PDA- or WAP-enabled phone device is being used, the system may send CDI 100 to the user in a format that is more appropriate for viewing on a display having a screen resolution commonly found on such devices (160×160, 480×320, amoung others).

At some point, the user will be presented with an opportunity to select one or more photos that are to be inserted into the CDI (block 215). As shown in FIG. 5A, the user may first select photo 130A for insertion into the CDI. This may not be the desired photo and so the user may repeat the photo selection process until the desired photo is identified. In the illustrated examples of FIGS. 5B-5D, the user next selects photos 130B and 130C, ultimately deciding upon photo 130D. Each time the user selects a particular photo for insertion, CDI 100 is dynamically updated with the new photo image. This dynamic updating function permits the user to freely create a composite dynamic image in a “what you see is what you get” (WYSIWYG) environment.

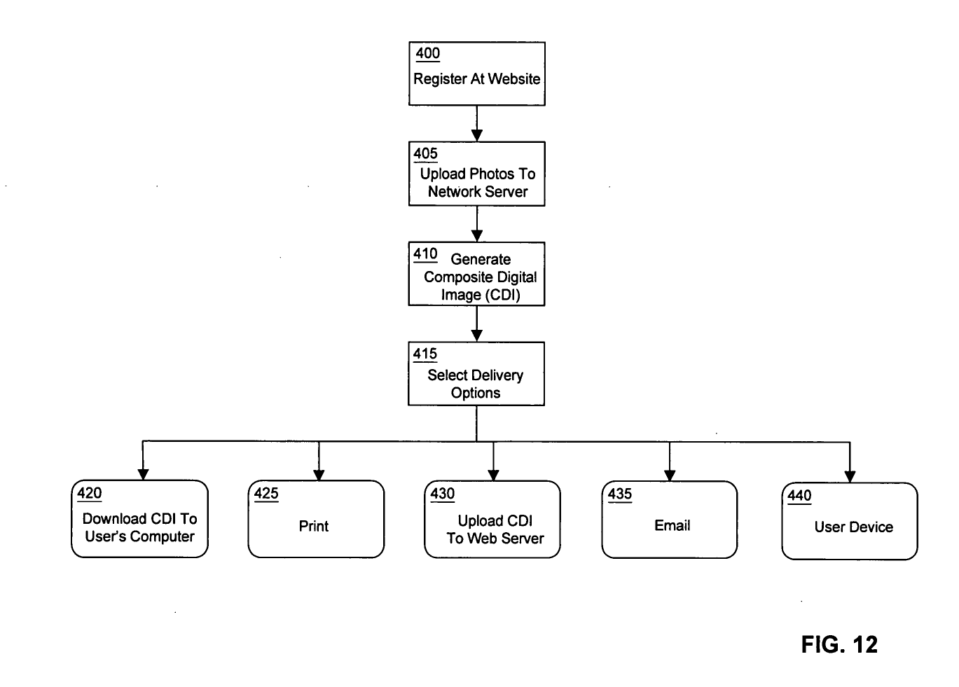

In accordance with one embodiment, the user will select photo image 130 from stored images 220. These photo images may be previously stored and remotely located at network server database 60. This aspect of the invention will be described in more detail in conjunction with FIG. 12.

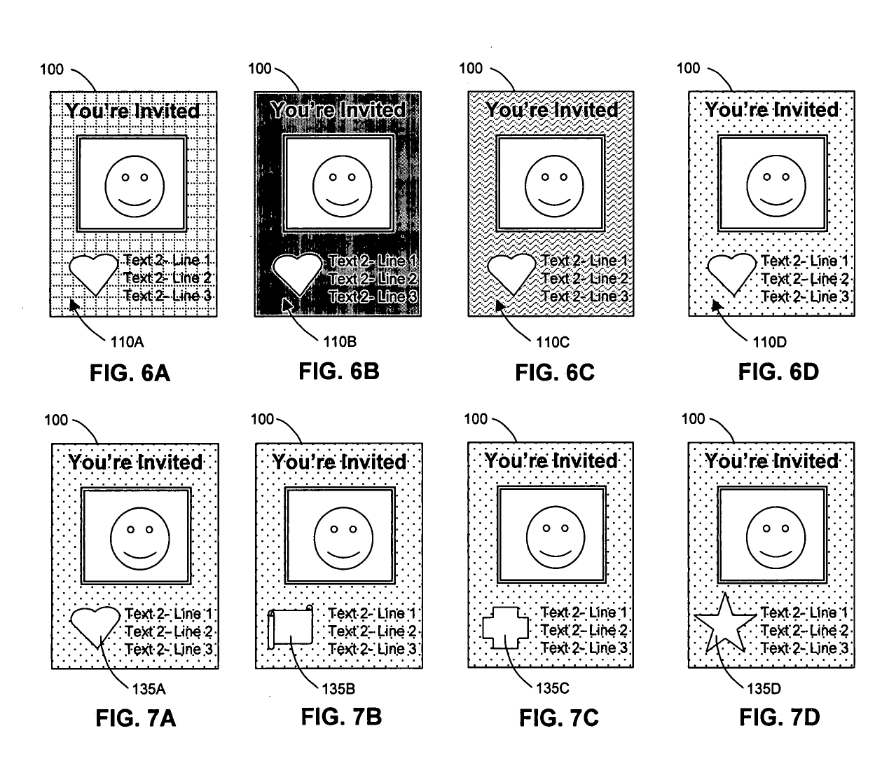

Each of the remaining template elements that form CDI 100 may be modified or selected in a similar manner. For example, referring next to block 225 of FIG. 3, the user may be allowed to modify or select the pattern of the background element of the CDI from the many choices available in background data 230. The background data is stored in image library 65. The examples of FIGS. 6A-6D show that a user may first select grid background 110A, causing the system to update CDI 100 with this background pattern. The user could then select background patterns 110B and 110C before ultimately selecting background pattern 110D.

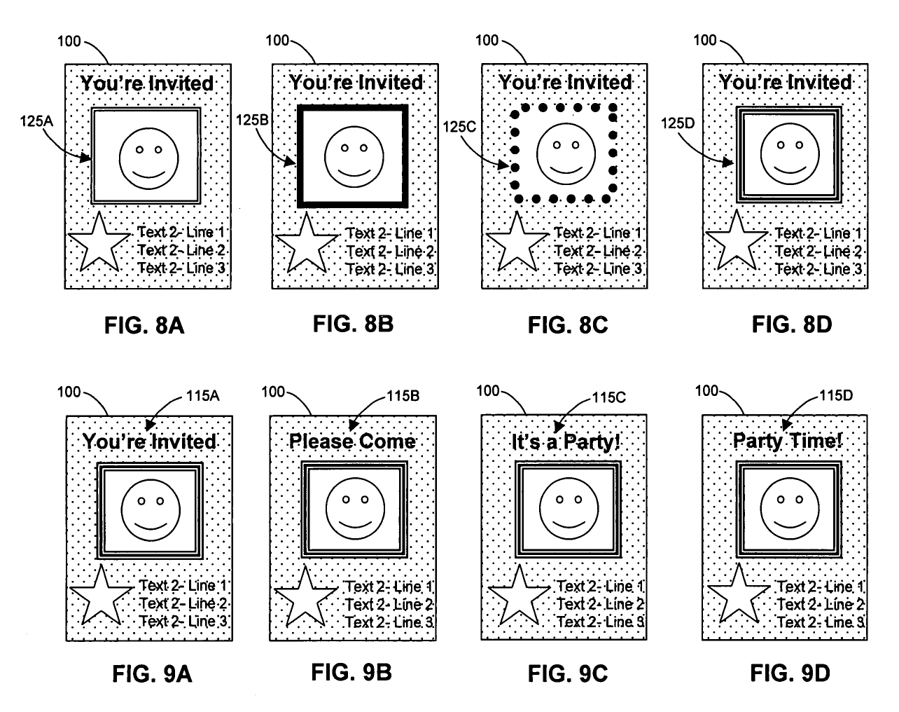

In block 235 of FIG. 3, the user can select or modify the graphical element of the CDI using various graphical figures available in graphical element data 240. As shown in block 245, the photo border element of the CDI may be selected from an assortment of photo borders available in border data 250. FIGS. 7A-7D show various graphical elements 135A-135D that may be used in the CDI, while FIGS. 8A-8D show possible photo border variations 125A-125D from which a user may choose.

FIG. 3 also illustrates some of the text editing capabilities of the system. As indicated by block 255, a user could be provided with the opportunity to modify or edit first or second text elements 115 or 120 using, in some instances, graphical data 260. A specific situation is one in which a user selects text from an assortment of titles or headings that broadly describe the general theme, for example, of the composite digital image. The examples of FIGS. 9A-9D are “You're Invited,” “Please Come,” “It's a Party!,” and “Party Time,” as indicated by text elements 115A-115D. The user is not limited to only changing the text that is contained with the text element, and may also be allowed to change or modify other text-related parameters such as font style, font size, color, justification, and the like.

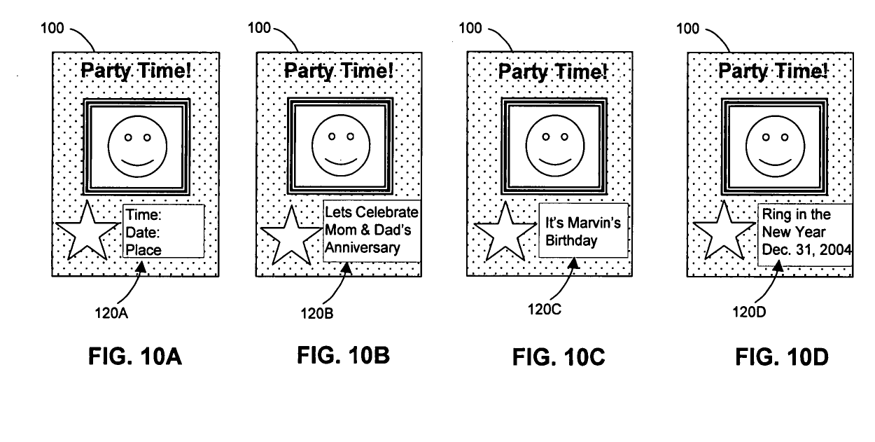

In some embodiments, the user may also be permitted to enter or modify any number of text elements of the CDI. FIGS. 10A-10D show four such examples, second text elements 120A-120D, where the user has entered a personalized message that is inserted into CDI 100. Note that the text for first and second text elements (115A-115D and 120A-120D) may be obtained from previously stored text data 260, or it may be user entered text, or some combination thereof.

After the user is satisfied with the generated CDI, the CDI image is typically stored for later retrieval. Referring back to FIG. 3, this image storage process may be accomplished using several different methods. One technique is to store the generated CDI as user data 265 at network server database 60 so that the CDI image is available for later use (for example, printing, viewing, emailing, and the like). If desired, the CDI may be stored at several different resolutions. For example, one version of the CDI may be stored at a sufficiently high resolution that is suitable for printing, while another version of the CDI is stored at a lower resolution that would be acceptable for viewing on a user's display. In a later printing operation, the higher resolution CDI image may be communicated to print server 30, for example, for printing on printer 75. In this particular implementation, the CDI image is a complete image and would not require any data from image library 70 for printing. Consequently, the image library would be an unnecessary component.

Another technique for storing CDI 100 is to separate or otherwise store the composite image in a file having two main file components. One file component, denoted in FIG. 3 as image 270, would include the photo image or images selected by the user in block 215. A second file component would include a software instruction set, written in a suitable computer language such as XML, HTML, C, C++, Java, amoung others, that describes each of the user selected template elements. Importantly, this second file component would not contain the various graphical images of the selected template elements. Instead, the graphic images of the template elements would be stored in image library 65 and in some situations, image library 70. In a later printing or viewing operation, for example, the system would generate CDI 100 according to stored software instruction set 275 and the stored user photo image 270.

Storing CDI 100 using the two-component file technique, rather than as a single composite image, has a few advantages. First, the stored image is considerably smaller in size than a combined image and thus, does not require as much space for storing on network database 60. This smaller file size also has decreased bandwidth requirements when communicating the file over a network.

FIG. 3 has been described with respect to the generation of a single CDI image having one or more user selected photos, but other embodiments are possible. For example, the entire process shown in FIG. 3 may be repeated any number of times to generate a corresponding number of CDI images.

Another alternative is where the user, at block 215, has selected more photo images than can be inserted into the selected template. As specific example is where the user selects ten photos, and has selected a particular template that only accommodates a single photo. In such a scenario, the system may generate ten different CDI images such that each CDI image includes a different one of the user selected photos.

Although the present invention may be implemented using the exemplary series of operations shown in FIG. 3, it is to be understood that additional or fewer template element editing operations may be performed. Moreover, it is to be understood that the order of operations shown in FIG. 3 is merely exemplary and that no single order of operation is required.

For example, in accordance with alternative embodiments, the user may select or otherwise identify the desired photos that are to be inserted into one or more CDI images at a time other than during the template element process. Specifically, the user may select the photos before selecting the desired theme of the CDI image. This may be accomplished by presenting the functionality of block 215 to the user before the theme selection option of block 200. Another alternative is to provide the user with the opportunity to define all of the desired template elements before selecting the desired photos. In this situation, the functionality of block 215 may be presented to the user after all of the remaining template element editing options (background selection 225, graphics selection 235, etc.) have been presented to the user.

Because of the dynamic nature and degree of customization offered by the system in creating CDI 100, it is not always necessary for the user to select a particular theme for the default template. Accordingly, the theme selection operation of block 200 may be omitted in some implementations of the invention. In these embodiments, the user would simply be provided the default template utilized in block 205 without actually having to specify this template.

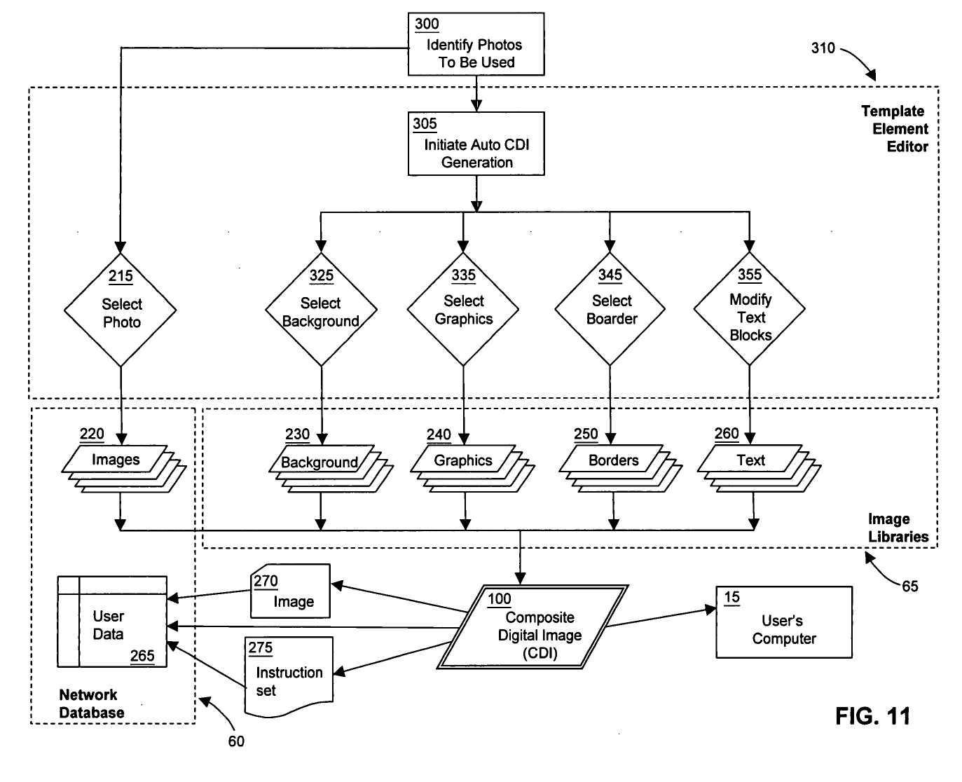

FIG. 11 is a block diagram showing various components of a digital image composite engine that may be used to generate CDI 100, according to an alternative embodiment of the invention. In this embodiment, the CDI is generated using an automated template generation process. This automated process may be a random or a pseudo random process, or the generation process could implement some form of artificial intelligence (AI). These automated processes have been described in more detail in conjunction with FIGS. 2A and 2B.

As before, CDI 100 may be generated by a user first contacting the appropriate website using, for example, the network arrangement of FIG. 1. As an initial step, as shown in block 300 of FIG. 11, the user may first be required to identify the photo image or images that are to be used in the generation of the CDI. As indicated by block 215, the user may select one or more photo images from previously stored images 220. Again, these photo images may have been previously stored and remotely located at network server database 60.

After the user has selected the desired photo images, the automated composite digital image process may be initiated, as indicated by block 305. The automated process generates the CDI by randomly, for example, selecting each of the template elements that form the CDI. In the example of FIG. 11, CDI 100 is automatically generated using the user selected images in conjunction with the template elements automatically selected in background selection 325, graphics selection 335, boarder selection 345, and text block modification 355.

Once generated, the CDI may then be presented to user computer 15 for viewing. If the user approves of the generated image, the CDI may be stored for later retrieval using any of the storage techniques described in conjunction with FIG. 3.

On the other hand, if the user is not satisfied with the generated image, the automated composite digital image process of block 305 may be re-initiated. This results in the generation of another version of CDI 100 which can be presented to user computer 15 for viewing and approval. This image generating and approval process may be repeated until the user is satisfied with the generated CDI image.

Although FIG. 11 is described with respect to the generation of a single CDI image having one or more user selected photos, the generation of multiple CDI images is possible using any of the techniques presented above in conjunction with FIG. 3.

FIG. 12 is a flowchart showing an exemplary process for the creation and subsequent delivery of a CDI image according to some embodiments of the invention. This figure will be described with occasional reference to the network environment of FIG. 1. Initially, as indicated by block 400, the user may use computer 15 to contact website 50. The website may prompt the user to enter customer information such as name, mailing address, telephone number, email address, and the like. The website may then assign the user with some sort of password for subsequent visits to the website. It is to be understood that each of the operations depicted in FIG. 12 may occur during a single visit to website 50, or during multiple visits to the website occurring over a period of time.

As indicated in block 405, the user will have the opportunity to upload photographic, graphical, or other types of digital images to server 25. These images may be stored for later use, during generation of CDI 100 for example, at network database 60. The uploaded photo images form a personalized image database that can be accessed by the user. The user may upload as few as one or two images, or several hundred images, or more.

In block 410, after the user images have been uploaded and stored at network database 60, the user can generate one or more CDI images using any of the techniques described in FIGS. 3 and 11, for example.

After the user has generated and approved of the CDI images, the system may then present the user with an assortment of delivery options, as indicated in block 415. One option, as noted in block 420, is to enable the user to download the generated CDI image to computer 15. This option enables the user to obtain the generated CDI image so that it can be freely distributed, printed, and viewed by the user.

Block 425 shows another option in which the user can initiate a print request. Such a print request may be implemented using any of the printing processes discussed above. For example, in accordance with some embodiments, this print request may ask for additional input from the user. In such a scenario, the user could be prompted to select from a number of predetermined or user selectable sizes and styles in which the finished product is printed (for example, 4×7, 5×7, 8×12, collage prints), the stock of the finished product (for example, photographic paper, shirt transfer, cake frosting sheet), as well as the number of desired copies of the CDI image.

Printing of the CDI image may be initiated by network server 25 communicating the generated CDI image to print server 30, causing the image to be printed by the appropriate printer 75. Typically, once the CDI image is printed as a completed order, the print is sent to the mailing address that the user provided during the registration process of block 400.

Alternatively or additionally, the completed and printed order may be sent to other people at separate addresses, as identified by the user during the registration process. This aspect of the invention enables the user to share the printed order with family and friends, without having to physically mail the actual prints themselves. A specific example is where the generated CDI image is a wedding announcement having a photo image of the engaged couple. During the registration process, for example, the user could supply the names and address of those on the wedding guest list. Then, as part of the delivery option process, the user could simply specify that each person identified in the guest list is to receive the printed copy of the wedding announcement.

Another deliver option is depicted in block 430. In this option, the generated CDI image is uploaded to a Web server (for example, computer 20) using information provided by the user during the registration process. This aspect enables the user to upload the generated CDI image to some predetermined or identifiable website for viewing by others.

Yet another delivery option involves electronically sending the generated CDI image to others using, for example, email or other suitable transfer methods (block 435). This electronic delivery option is similar in many respects to the printing option of block 425. For example, once the user generated CDI image is generated, it may be electronically sent to others at particular email addresses identified by the user during the registration process. This aspect of the invention enables the user to electronically share the generated CDI with others, without having to go to the trouble of having to actually email each person individually. Another alternative is to communicate the CDI image to a user or display device 440, such as an electronic picture frame, wireless telephone, PDA, kiosk, or other retail location, that is in network communication with server 25 or computer 15. Note that the user may be given the opportunity to select from all of the delivery options shown FIG. 12, but this is not a requirement and the user may alternatively be presented with a limited choice of delivery options.

The present invention has been described in the context of a web-based environment with remote printing capabilities, but various alternatives are envisioned. Referring back to FIG. 1, one such alternative is where the functionality of the digital image composite engine website 50 is implemented in software executing on a computer without the need for a network connection. Such a configuration may be implemented by providing computer 15 with the necessary software to perform the functions provided by the digital image composite engine, as well as the necessary data contained within databases 60 and 65. In this configuration, the user could create the CDI image using locally residing software, and print the generated images using attached printer 45, for example. Alternatively or additionally, the user could communicate the generated CDI image to print server 30 for printing.

Note also that network server 25 and print server 30 have been described as distinct components, but this is not a requirement. If desired, the network server 25 may be additionally configured with the necessary printing capabilities provided by print server 30, thus eliminating the need for a separate print server.

While the invention has been described in detail with reference to disclosed embodiments, various modifications within the scope of the invention will be apparent to those of ordinary skill in this technological field. It is to be appreciated that features described with respect to one embodiment typically may be applied to other embodiments. Therefore, the invention properly is to be construed only with reference to the claims.

1. A system for generating a user-customized composite digital image, said system comprising:
a first database having one or more digital images;
a second database having a library of template element images;
a third database having a library of at least one composite digital image template, wherein each composite digital image template within said library comprises one or more user modifiable template elements, and one or more locations where an identified one or more of said digital images can be located;
a template element editor for selectively changing said one or more user modifiable template elements associated with said composite digital image template using images obtained from said library of template element images; and
a rendering unit for combining said composite digital image template with said identified one or more of said digital images and said one or more user modifiable template elements to generate said user-customized composite digital image.

2. The system according to claim 1, said system further comprising:
a theme selector for selecting a composite digital image template from said library of at least one composite digital image template.

3. The system according to claim 1, said system further comprising:
a fourth database for storing said user-customized composite digital image at different resolutions, wherein a first resolution of said different resolutions is a relatively higher resolution image suitable for printing, and wherein
a second resolution of said different resolutions is a relatively lower resolution image suitable for displaying on a user's display.

4. The system according to claim 1, said system further comprising:
a fourth database for storing said user-customized composite digital image using different file components, wherein a first component of said different file components comprises said identified one or more of said digital images, and wherein
a second component of said different file components comprises computer instruction code necessary to generate said composite digital image template with said one or more user modifiable template elements.

5. The system according to claim 1, wherein said template element editor comprises a menu presenting various user selectable image options for changing said one or more user modifiable template elements, wherein said image options comprise images obtained from said library of template element images.

6. The system according to claim 1, wherein said template element editor comprises a tool bar presenting various user selectable image options for changing said one or more user modifiable template elements, wherein said image options comprise images obtained from said library of template element images.

7. The system according to claim 1, wherein said template element editor presents options for changing said one or more user modifiable template elements using a multi-stage interactive wizard, wherein each stage of said interactive wizard presents different image options for changing said one or more user modifiable template elements, wherein said different image options comprise images obtained from said library of template element images.

8. The system according to claim 1, wherein said template element editor utilizes a drag-and-drop process for selectively changing said one or more user modifiable template elements.

9. The system according to claim 1, wherein said template element editor utilizes a user initiated automated process that automatically changes said one or more user modifiable template elements.

10. The system according to claim 1, said system further comprising:
a delivery option interface identifying options for delivery of said user-customized composite digital image.

11. The system according to claim 10, wherein said options for delivery include an option for printing said user-customized composite digital image.

12. The system according to claim 10, wherein said options for delivery include an option for downloading a digital file containing said user-customized composite digital image to a local computer.

13. The system according to claim 10, wherein said options for delivery include an option for uploading a digital file containing said user-customized composite digital image to a remote network server.

14. The system according to claim 10, wherein said options for delivery include an option for emailing a digital file containing said user-customized composite digital image to a specified one or more email accounts.

15. The system according to claim 10, wherein said options for delivery include an option for printing said user-customized composite digital image and arranging for delivery of said printed user-customized composite digital image to one or more locations specified by a user of said system.

16. The system according to claim 1, wherein said user-customized composite digital image is rendered on a user's display.

17. The system according to claim 1, wherein said template element editor is presented on a computer display.

18. The system according to claim 1, wherein said template element editor is presented on a display of a wireless computing device.

19. The system according to claim 1, wherein said template element editor is presented on a display of a wireless telephone.

20. The system according to claim 1, wherein said first, second, and third databases are configured as a single database.

21. The system according to claim 1, wherein said first, second, and third databases are remotely located relative to a user's computer, said computer having a display for presenting said template element editor.

22. The system according to claim 1, wherein said first, second, and third databases are stored on a local storage device of a user's computer, said computer having a display for presenting said template element editor.

23. The system according to claim 1, wherein said template element editor is implemented in software executing on a user's computer.

24. The system according to claim 1, wherein said template element editor is implemented in software executing at least partially on a network server that is in communication with a user's computer.

25. The system according to claim 1, wherein said one or more user modifiable elements are selected from the group consisting of background, photo border, graphics, and text block.

26. The system according to claim 1, wherein said template element editor is further configured for selectively entering user supplied text into one or more text elements associated with said composite digital image template, and wherein
said rendering unit is further configured to combine said one or more text elements with said composite digital image template, said identified one or more of said digital images, and said one or more user modifiable template elements to generate said user-customized composite digital image.

27. The system according to claim 1, wherein said one or more digital images are user supplied digital images.

28. A method for generating a user-customized composite digital image, said method comprising:
providing a composite digital image template from a library of at least one composite digital image template, wherein each composite digital image template stored in said library comprises one or more user modifiable template elements, and one or more locations where an associated one or more digital images can be located;
modifying said one or more user modifiable template elements using images stored in a library of template element images; and
generating said user-customized composite digital image by combining said composite digital image template, said one or more digital images, and said one or more user modifiable template elements.

29. The method according to claim 28, said method further comprising:
selecting said composite digital image template from said library of at least one composite digital image template.

30. The method according to claim 28, said method further comprising:
storing said user-customized composite digital image in different resolutions, wherein a first resolution of said different resolutions is a relatively higher resolution image suitable for printing, and wherein
a second resolution of said different resolutions is a relatively lower resolution image suitable for displaying on a user display.

31. The method according to claim 28, said method further comprising:
storing said user-customized composite digital image using different file components, wherein a first component of said different file components comprises said identified one or more user digital images, and wherein
a second component of said different file components comprises computer instruction code necessary to generate said composite digital image template and said one or more user modifiable template elements.

32. The method according to claim 28, said method further comprising:
presenting various image options for changing said one or more user modifiable template elements in a menu, wherein said image options comprise images obtained from said library of template element images.

33. The method according to claim 28, said method further comprising:
presenting various image options for changing said one or more user modifiable template elements in a tool bar, wherein said image options comprise images obtained from said library of template element images.

34. The method according to claim 28, said method further comprising:
presenting options for changing said one or more user modifiable template elements using a multi-stage interactive wizard, wherein each stage of said interactive wizard presents different image options for changing said one or more user modifiable template elements, wherein said different image options comprise images obtained from said library of template element images.

35. The method according to claim 28, said method further comprising:
utilizing a drag-and-drop process for selectively changing said one or more user modifiable template elements.

36. The method according to claim 28, said method further comprising:
automatically changing said one or more user modifiable template elements responsive to user input.

37. The method according to claim 28, said method further comprising:
presenting various options for delivery of said user-customized composite digital image.

38. The method according to claim 28, said method further comprising:
presenting various options for printing of said user-customized composite digital image.

39. The method according to claim 28, said method further comprising:
presenting an option for downloading a digital file containing said user-customized composite digital image to a local computer.

40. The method according to claim 28, said method further comprising:
presenting an option for uploading a digital file containing said user-customized composite digital image to a remote network server.

41. The method according to claim 28, said method further comprising:
presenting an option for emailing a digital file containing said user-customized composite digital image to a specified one or more email accounts.

42. The method according to claim 28, said method further comprising:
presenting an option for printing said user-customized composite digital image and arranging for delivery of said printed user-customized composite digital image to one or more locations specified by a user.

43. The method according to claim 28, said method further comprising:
rendering said user-customized composite digital image on a user's display.

44. The method according to claim 28, said method further comprising:
presenting said template element editor on a computer display.

45. The method according to claim 28, said method further comprising:
presenting said template element editor on a display of a wireless computing device.

46. The method according to claim 28, said method further comprising:
presenting said template element editor on a display of a wireless telephone.

47. The method according to claim 28, said method further comprising:
storing said one or more digital images, said library of at least one composite digital image template, and said library of template element images, in a database that is remotely located relative to a user's computer.

48. The method according to claim 28, said method further comprising:
storing said one or more digital images, said library of at least one composite digital image template, and said library of template element images, on a local storage device of a user's computer.

49. The method according to claim 28, wherein said modifying is implemented in software executing on a user's computer.

50. The method according to claim 28, wherein said modifying is implemented in software executing at least partially on a network server that is in communication with a user's computer.

51. A system for generating a user-customized composite digital image, said system comprising:
first memory means for storing one or more digital images;
second memory means for storing a library of template element images;
third memory means for storing at least one composite digital image template comprising one or more user modifiable template elements, and one or more locations where an identified one or more of said digital images can be located;
means for selectively changing said one or more user modifiable template elements associated with said composite digital image template using images obtained from said library of template element images; and
means for combining said selected composite digital image template with said identified one or more of said digital images and said one or more user modifiable template elements to generate said user-customized composite digital image.
